(19) United States
(12) Patent Application Publication
(10) Pub. No.: US 2021/0181790 A1
(43) Pub. Date: Jun. 17, 2021

(54) Reversible Display Band

(71) Applicant: David Patrick Jones, Hampton, NJ (US)

(72) Inventor: David Patrick Jones, Hampton, NJ (US)

(21) Appl. No.: 16/712,321

(22) Filed: Dec. 12, 2019

(51) Int. Cl. G06F 1/16; A63B 71/06

(52) U.S. Cl. CPC G06F 1/163; A63B 2071/0663; A63B 71/0619

(57) ABSTRACT

A reversible display band is used to provide a reconfigurable display that can be worn by athletes. The reversible band has a band, a strap, a flap, and a pair of mounting panels. The band is a flexible strip of material and the strap is used to detachably mate the two ends of the band. The mounting panels are fastening systems that enable a user to attach any number of patches and other visual indicators to the display band. To facilitate this functionality, the mounting panels are laterally attached to opposite sides if the band. The flap is mounted along a lengthwise edge of the band so that the user can lay the flap over whichever mounting panel the user wants to be obscured. The user then attaches the display band to themselves and the unobscured mounting panel is presented for visual inspection.

### FIELD OF THE INVENTION

The present invention relates generally to sporting equipment. More specifically, the present invention relates to a reconfigurable display band that is designed to be wrapped around a user's limb.

### BACKGROUND OF THE INVENTION

Communication is important on a sports field and enables athletes, referees, and spectators to keep track of the field of play. Chaos is bound to happen when an athlete cannot distinguish their teammates from competitors. Additionally, it may be useful to enable the athlete to change the information presented on their jersey. For example, a quarterback may want to covertly notify teammates that they will be running instead of passing. The present invention is a device that enables the athlete to present various pieces of information without verbally communication or using hand signals.

To achieve this functionality, the present invention provides as a reconfigurable band that can be attached to the athlete's body and then used to passively output information. The reconfigurable band is designed with mounting panels superimposed onto the sides of the band. The mounting panels function as anchor points for visual output devices which enable the athlete to convey information without taking focus off the game. The athlete is able to change the visual indicators on the mounting panels as desired. Thus, enabling the athlete to quickly and covertly communicate information to teammates, competitors, officials, and anyone else watching the game. The display band also includes a flap that can be laid over whichever mounting panel is pressed against the user's body. Thus, protecting the visual indicators arranged thereon. The display band also makes use of reversible straps and fasteners to enable the athlete to quickly transition between sides.

### BRIEF DESCRIPTION OF THE DRAWINGS

FIG. 1 is an isometric perspective view of the present invention.

FIG. 2 is a front view of the present invention.

FIG. 3 is a rear view of the present invention.

FIG. 4 is a left-side view of the present invention.

FIG. 5 is a right-side view of the present invention.

FIG. 6 is a front view of the present invention in a first configuration.

FIG. 7 is a front view of the present invention in a second configuration.

FIG. 8 is an isometric perspective view of the present invention showing a plurality of detachable patches connected to a mounting panel.

### DETAIL DESCRIPTIONS OF THE INVENTION

All illustrations of the drawings are for the purpose of describing selected versions of the present invention and are not intended to limit the scope of the present invention.

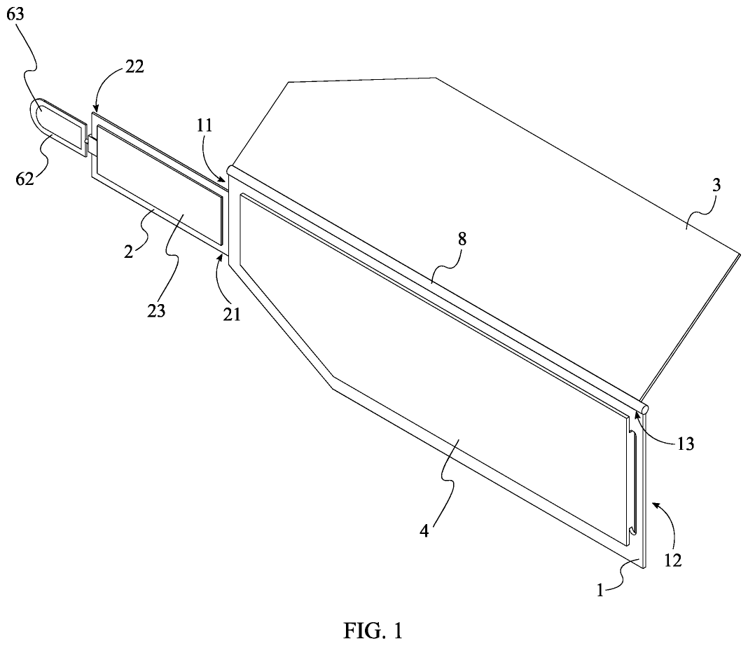

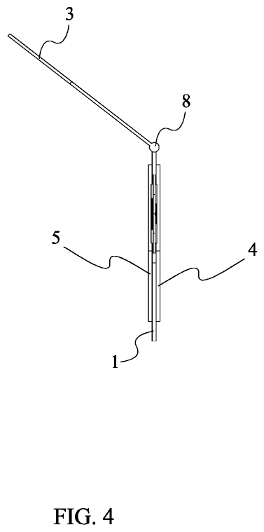

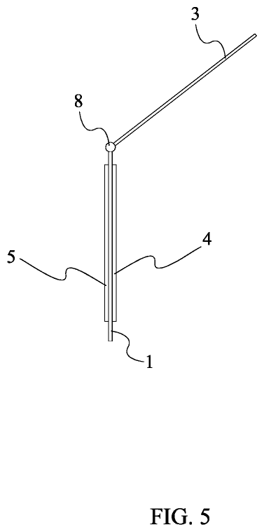

Referring to FIG. 1 through FIG. 8, the present invention, the reversible display band, is a sports accessory used to present team information and personal flair. Specifically, the present invention is a reversible armband that has two reconfigurable display panels. To employ the present invention, a user configures one or more display panel and then wraps the present invention around a portion of the body or a piece of equipment. Members of all teams involved in a sporting event will then be able to glean important pieces of player information through visual inspection alone. To achieve this functionality, the present invention comprises a display band 1, a strap 2, a flap 3, at least one first mounting panel 4, and at least one second mounting panel 5. The display panel is a flexible strip of material that is that is designed to display athlete-selected information. As described above, the display band 1 is a flexible strip of material. As such, a first end 11 of the display band 1 is positioned opposite to the second end 12 of the display band 1 along the display band 1. Additionally, a fixed end 21 of the strap 2 is connected to the first end 11 of the display band 1. Additionally, a free end 22 of the strap 2 is and detachably connected to the second end 12 of the display band 1. As a result, the strap 2 is used to secure the display band 1 around the user's arm. Preferably, the strap 2 is a length-adjustable device that can be modified to accommodate users of varying shape and size. Some embodiments are designed with straps 2 made of elastic materials that stretch to accommodate users of varying shape and size.

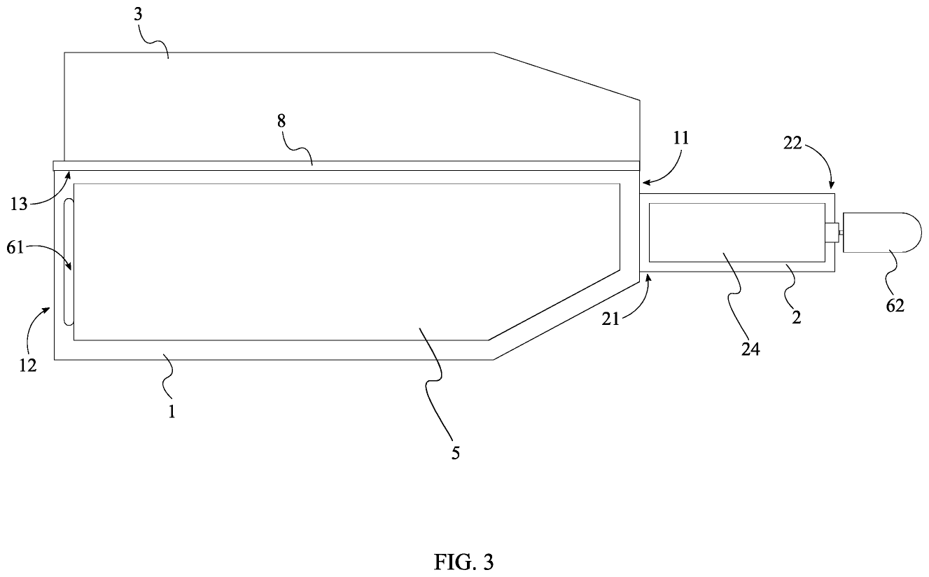

Referring to FIG. 1 and FIG. 3, the first mounting panel 4 and the second mounting panel 5 are planar devices that function as the anchor points for a plurality of visual indicator devices. Preferably, the first mounting panel 4 and the second mounting panel 5 are each panels with hook and loop fasteners superimposed onto one side. The first mounting panel 4 is connected adjacent to the display band 1. Likewise, the second mounting panel 5 is connected adjacent to the display band 1, opposite to the first mounting panel 4. Thus, the first mounting panel 4 and the second mounting panel 5 enable the user to mount a first set of visual indicators onto an outward-facing side of the display band 1 while mounting a separate second set of visual indicators onto an inward-facing side of the display band 1. Further, this reversible functionality enables the user to selectively display the first set of visual indicators or the second set of visual indicators by switching the side of the display band 1 that is considered to be the outward-facing side. To facilitate this functionality, the flap 3 is connected along a lengthwise edge 13 of the display band 1 and is positioned in between the first end 11 and the second end 12. Accordingly, the flap 3 can be laid over the first mounting panel 4 or the second mounting panel 5 to protect the visual indicators attached to the inward-facing side of the display band 1.

Referring to FIG. 1 and FIG. 3, the reversible functionality is enabled through the use of a fastener capable of mating the free end 22 of the strap 2 to the second end 12 of the display band 1 regardless of whether the first mounting panel 4 is on the outward-facing side of the display band 1 or the inward-facing side. To that end, the present invention further comprises a fastening mechanism 6 that comprises a hole 61, a reversible fastener 62, and an interfacing surface 63. Additionally, the strap 2 further comprises a first attachment panel 23 and a second attachment panel 24. The first attachment panel 23 and the second attachment panel 24 are planar devices that function as the anchor points for the fastening mechanism 6. That is, embodiments may utilize various forms of fastening systems including, but not limited to, magnetic couplers, adhesives, hook and loop fasteners, and mechanical mechanisms as the first and second attachment panels. The reversible fastener 62 is a fastening device that can be swiveled and then mated to a corresponding surface. The hole 61 normally traverses through the display band 1 and is positioned adjacent to the second end 12 of the display band 1. Additionally, the reversible fastener 62 is articulatably mounted onto the first end 11 and the free end 22 of the strap 2 is threaded through the hole 61. Thus, the fastening mechanism 6 and the strap 2 work in concert to mate the first end 11 of the display band 1 to the second end 12 of the display band 1. Further, the reversible fastener 62 is able to be swiveled, bent, and otherwise repositioned to mate to the attachment panel positioned on the outward-facing side of the display band 1.

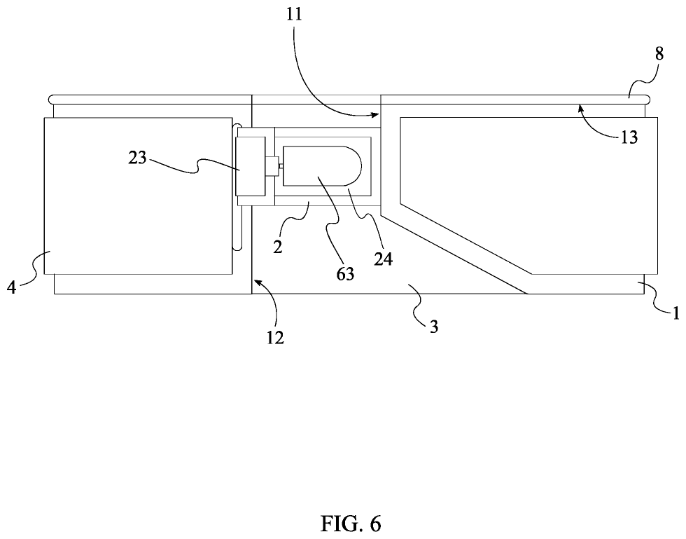

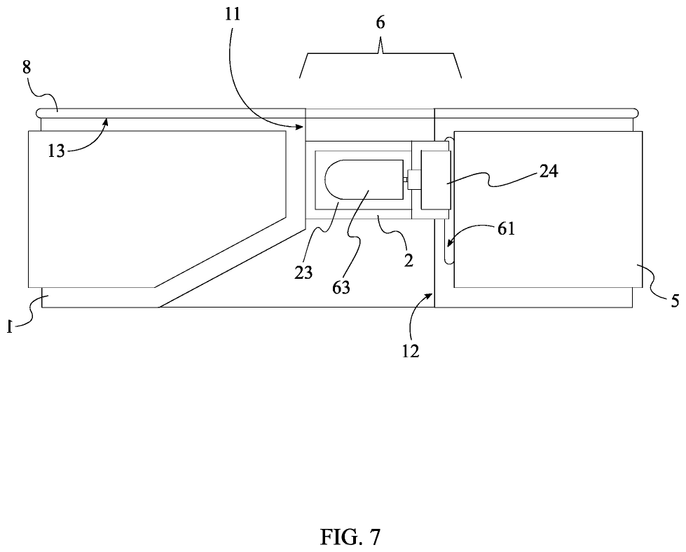

Referring to FIG. 1 FIG. 6, and FIG. 7, once the strap 2 is threaded through the hole 61, the user is able to swivel the reversible fastener 62 to facilitate becoming attached to whichever side of the strap 2 is oriented toward the outward-facing side of the display band 1. The first attachment panel 23, the second attachment panel 24, and the interior-facing surface are components of a two-component detachable fastener. In this two-component system, the first attachment panel 23 and the second attachment panel 24 are each a copy of the first component and the interfacing surface 63 is a second component that is capable of being attached to either the first attachment panel 23 or the second attachment panel 24. To facilitate this, the interfacing surface 63 is laterally connected to the reversible fastener 62. Additionally, the first attachment panel 23 is connected adjacent to the strap 2. Further, the second attachment panel 24 is connected adjacent to the strap 2, opposite to the first attachment panel 23. Accordingly, the interfacing surface 63 is attached to the first attachment panel 23 when the first mounting panel 4 is positioned on the outward-facing side of the display band 1. Likewise, the interfacing surface 63 is attached to the second attachment panel 24 when the second mounting panel 5 is positioned on the outward-facing side of the display band 1. Some alternative embodiments are designed with reversible fasteners 62 that can be engaged or disengaged irrespective of which side of the display band 1 is considered to be the outward-facing side.

Referring to FIG. 1 FIG. 6, and FIG. 7, the display band 1 is designed to be transitioned between a first configuration and a second configuration. These two configurations correspond to the position of the first mounting panel 4, the second mounting panel 5, and the flap 3. Specifically, the flap 3 is positioned adjacent to the second mounting panel 5 and the interfacing surface 63 is attached to the first attachment panel 23 while the display band 1 is in the first configuration. Thus, the first mounting panel 4 is positioned on the outward-facing side of the display band 1 while in the first configuration. Further, the flap 3 is used to cover and protect the second mounting panel 5 while in the first configuration. The second configuration is the opposite situation. That is, the flap 3 is positioned adjacent to the first mounting panel 4 and the interfacing surface 63 is attached to the second attachment panel 24 while the display band 1 is in the second configuration. Thus, the second mounting panel 5 is positioned on the outward-facing side of the display band 1 while in the second configuration. Further, the flap 3 is used to cover and protect the first mounting panel 4 while in the second configuration.

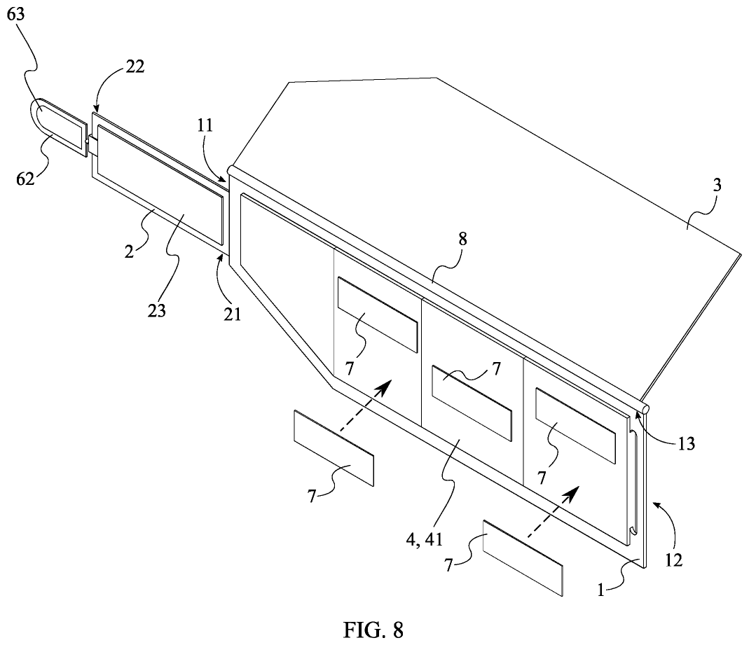

Referring to FIG. 1, FIG. 6, and FIG. 8, the present invention is designed to enable the user to customize the information presented on the first display band 1 and the second display band 1. To facilitate this functionality, the present invention further comprises a plurality of detachable patches 7. Each of the plurality of detachable patches 7 is a visual indicator device used to visually output information. The plurality of detachable patches 7 contains devices including, but not limited to fabric signs, electronic displays, and lighting devices. A subset of the plurality of detachable patches 7 is mounted onto the first mounting panel 4 so that the user can customize the information presented on the display band 1 as desired. In some embodiments the at least one first mounting panel 4 is a plurality of first mounting panels 4. In these embodiments the plurality of first mounting panels 4 is distributed along the display band 1. Additionally, each of the plurality of detachable patches 7 is mounted onto a corresponding first panel 41 from the plurality of first mounting panels 4. As a result, the user is able to mount each of the plurality of detachable patches 7 onto a unique mounting panel. Thereby enabling standardization of the information presented on the user's display band 1.

Referring to FIG. 1, FIG. 7, and FIG. 8, the mounting strategy is identical for the second mounting panel 5. Specifically, a subset of the plurality of detachable patches 7 is mounted onto the second mounting panel 5 so that the user can customize the information presented on the display band 1 as desired. In some embodiments the at least one second mounting panel 5 is a plurality of second mounting panels 5. In these embodiments the plurality of second mounting panels 5 is distributed along the display band 1. Additionally, each of the plurality of detachable patches 7 is mounted onto a corresponding second panel 51 from the plurality of second mounting panels 5. As a result, the user is able to mount each of the plurality of detachable patches 7 onto a unique mounting panel. Thereby enabling standardization of the information presented on the user's display band 1.

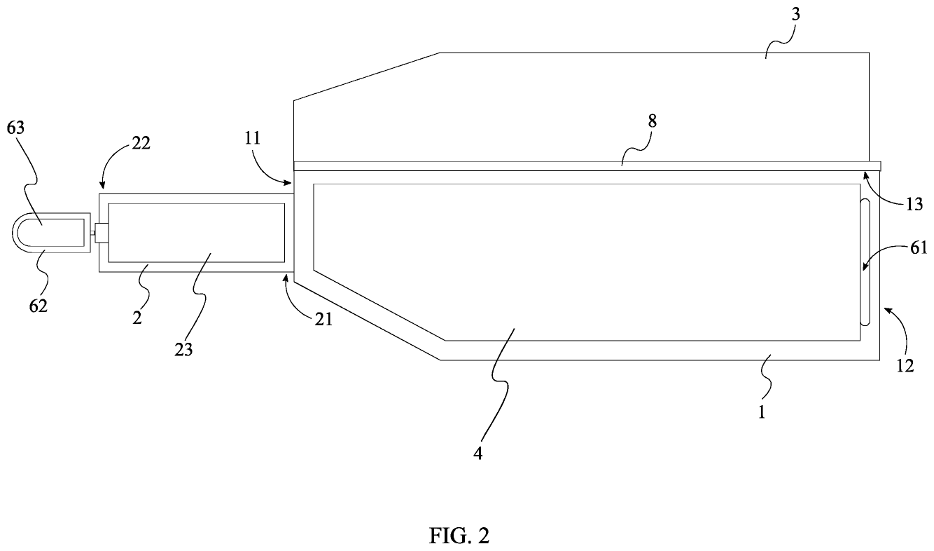

Referring to FIG. 1, FIG. 2, and FIG. 3, the present invention is designed to remain in place even when being worn while the engages in vigorous activities. To that end, the present invention further comprises a flexible spine 8. The flexible spine 8 is a tube of semirigid material that is integrated along the lengthwise edge 13. Accordingly, the flexible spine 8 provides a cinching force to retain the present invention in place when wrapped around the user's body. For example, the display band 1 may be wrapped around the user's arm above the bicep. In this configuration, the flexible spine 8 decreases the overall circumference of the display band 1. Thus, preventing the present invention from sliding down the user's arm. Further embodiments feature a flexible spine 8 that can be detached from the display band 1. Additional embodiments feature padding that is integrated into the display band 1. Some embodiments feature mounting panels that can be used to hold smartphones and other electronic devices. Related embodiments are designed to use mounting panels that employ fasteners including, but not limited to, magnets, adhesives, and interlocking couplers.

Although the invention has been explained in relation to its preferred embodiment, it is to be understood that many other possible modifications and variations can be made without departing from the spirit and scope of the invention as hereinafter claimed.

What is claimed is:

1. A reversible display band comprising:
a display band;
a strap;
a flap;
at least one first mounting panel;
at least one second mounting panel;
a first end of the display being positioned opposite to a second end of the display band, along the display band;
a fixed end of the strap being connected to the first end;
a free end of the strap being and detachably connected to the second end;
the first mounting panel being connected adjacent to the display band;
the second mounting panel being connected adjacent to the display band, opposite to the first mounting panel;
the flap being connected along a lengthwise edge of the display band; and
the flap being positioned in between the first end and the second end.

2. The reversible display band as claimed in claim 1 comprising:
a fastening mechanism;
the strap comprising a first attachment panel and a second attachment panel;
the fastening mechanism comprising a hole, a reversible fastener, and an interfacing surface;
the hole normally traversing through the display band;
the hole being positioned adjacent to the second end;
the reversible fastener being articulatably mounted onto the free end; and
the free end being threaded through the hole;
the interfacing surface being laterally connected to the reversible fastener. the first attachment panel being connected adjacent to the strap; and
the second attachment panel being connected adjacent to the strap, opposite to the first attachment panel.

3. The reversible display band as claimed in claim 2 comprising:
wherein the display band being in a first configuration;
the flap being positioned adjacent to the second mounting panel; and
the interfacing surface being attached to the first attachment panel.

4. The reversible display band as claimed in claim 2 comprising:
wherein the display band being in a second configuration;
the flap being positioned adjacent to the first mounting panel; and
the interfacing surface being attached to the second attachment panel.

5. The reversible display band as claimed in claim 1 comprising:
a plurality of detachable patches; and
the plurality of detachable patches being mounted onto the first mounting panel.

6. The reversible display band as claimed in claim 1 comprising:
a plurality of detachable patches;
the at least one first mounting panel being a plurality of first mounting panels;
the plurality of first mounting panels being distributed along the display band; and
each of the plurality of detachable patches being mounted onto a corresponding first panel from the plurality of first mounting panels.

7. The reversible display band as claimed in claim 1 comprising:
a plurality of detachable patches; and
the plurality of detachable patches being mounted onto the second mounting panel.

8. The reversible display band as claimed in claim 1 comprising:
a plurality of detachable patches;
the at least one second mounting panel being a plurality of second mounting panels;
the plurality of second mounting panels being distributed along the display band; and
each of the plurality of detachable patches being mounted onto a corresponding second panel from the plurality of second mounting panels.

9. The reversible display band as claimed in claim 1 comprising:
a flexible spine; and
the flexible spine being integrated along the lengthwise edge.

10. The reversible display band as claimed in claim 1, wherein the first mounting panel and the second mounting panel comprise a plurality of hook and loop fasteners.
